(19) United States
(12) Patent Application Publication
(10) Pub. No.: US 2006/0153948 A1
(43) Pub. Date: Jul. 13, 2006

(54) Habitat for caged animals and method of improving animal environment

(76) Inventors: Joseph P. Markham, Arvada, CO (US); Thomas Kieth Martin, Amarillo, TX (US)

Correspondence Address: SHERIDAN ROSS PC, 1560 BROADWAY, SUITE 1200, DENVER, CO, 80202, US

(21) Appl. No.: 11/372,669

(22) Filed: Mar. 9, 2006

Related U.S. Application Data
(62) Division of application No. 10/836,455, filed on Apr. 30, 2004.
Application No. 10/836,455 is a continuation-in-part of application No. 10/431,490, filed on May 6, 2003.

(51) Int. Cl. A23K 1/18

(52) U.S. Cl. 426/2

(57) ABSTRACT

Habitat for caged animals is manufactured from extruded milo grain. Preferably, the grain is defatted and decorticated. By selectively altering the moisture content of the grain as well as selectively altering the particular extrusion process, habitat may be formed in various shapes, sizes, and densities. The disclosure provides a method of introducing an extruded milo grain to the environment of the animal, and observing the behavior of the animal to provide the type of product that best suits the animal's particular behavior.

### CROSS REFERENCE TO RELATED APPLICATION

This application is a continuation-in-part of copending U.S. patent application Ser. No. 10/431,490, filed May 6, 2003, entitled “Pet Food Treat and Method of Making Same.”

### FIELD OF THE INVENTION

The present invention relates to habitat for caged animals, such as laboratory animals, and more particularly to habitat in the form of an extruded milo grain in many different shapes, sizes and densities, as well as a method of improving an animal's environment by providing the extruded milo habitat.

### BACKGROUND OF THE INVENTION

Laboratory animals are widely used for research and development in the medical field, particularly in the pharmaceutical industry. Many countries require testing of some new drugs and methods of treatments on animals prior to conducting clinical studies with humans. Because of strict regulatory requirements in proving the safety and effectiveness of new drugs and treatments, researchers who use laboratory animals for research and testing must ensure that the environment of the animal is not altered in a manner that will invalidate the particular study undertaken. For example, an animal that contracts a disease during the study can be disqualified for use, or an animal who routinely ingests articles in the cage may undesirably alter the prescribed diet of the animal which also results in invalidation of the particular study undertaken.

Rodents often used in research and development, such as mice, rats, hamsters, and the like, have instinctual behaviors characterized by nesting, and burrowing or tunneling for nesting purposes. Also, these animals use their large incisors for gnawing to create a nest from surrounding materials.

One undesirable behavior that is exhibited by many laboratory animals is the “Hotel Syndrome,” a term given to describe behavior characterized by pacing from one end of the cage to another, or otherwise engaging in repetitive physical acts. This type of behavior is indicative of an animal that is unduly stressed, and therefore unsuitable for study. Efforts have been made to enhance the environment of laboratory animals to reduce the Hotel Syndrome.

Some studies suggest that relaxed, unstressed test animals are more likely to exhibit normal behaviors thereby producing more reproducible and reliable test results.

These studies showed that test rodents would seek additional cage space and self-administer antidepressant drugs when housed in confined habitats in the absence of materials to chew or nest in. Sherwin, Animal Behaviour (2004); Sherwin et al., Animal Welfare 13:33-9 (2004).

Therefore, there is a need for a product which can be used as habitat for caged animals that enriches or enhances their caged environment, and that will allow the animals to pursue their natural instincts such as burrowing and nesting. There is also a need for such a product that will not endanger the health of the animals, or otherwise affect the testing performed on the animals.

One example of habitat provided for caged animals is disclosed in the U.S. Pat. No. 6,584,934. The habitat disclosed in this reference is a three-dimensional structure, referred to as an envelope, that may be constructed of biodegradable, edible or food grade material. The material used may have various purposes to include use as litter, food, medicaments, or toys.

Another reference disclosing habitat for caged animals includes the U.S. Pat. No. 5,289,795. This reference describes a product comprised of a hollow housing, such as bone or pipe, having a cavity therein that is accessible from outside the housing by at least one opening. The cavity is large enough for an animal to burrow in, and may be filled with food suitable for the animal to consume. In addition to bone and pipe, the housing may be constructed of stone, wood, plastic, rubber, metal, cement, shell, plaster, and may further contain various minerals and vitamins. The food that may be placed within the housing may include nuts, seeds, fruits, beans, gains, fats, oils, sugars and yeast.

Yet another example of habitat for animals such as rodents is disclosed in U.S. Pat. No. 5,752,469. The habitat described in this reference is a housing formed from a coconut shell.

It is well known to use various types of cereal grains in an extrusion process to produce animal feed. For example, one reference that discloses a method of making a pet snack food by extrusion of various types of cereal grains is the U.S. Pat. No. 5,894,029.

Additionally, it is also known to use grains for animal litter thereby absorbing animal waste. U.S. Pat. No. 6,014,947 discloses this use of grain in the form of ground grain litter derived from wheat varieties including white wheat, spring wheat, winter wheat, durum and combinations thereof. In one embodiment, the litter product can include a natural agent, such as milo grain, to reduce the dusting tendency of the ground grain litter.

### SUMMARY OF THE INVENTION

One object of the present invention is to provide habitat for caged animals that will pose a minimum risk to the health of the animal if consumed. Another object of the present invention is to provide habitat for caged animals that, if ingested, will provide minimal food value to the animal. Thus, if the animal must follow a regimented diet, it will not be substantially disrupted by the animal's destruction and/or consumption of the habitat.

It is another object of the present invention to provide habitat for caged animals that may be produced in many different shapes, densities, and sizes thereby diversifying use of the habitat to enrich the animals' environments. Another object of the present invention is to provide a natural product that is inexpensive and biodegradable thus easing the cost of use and disposal.

In accordance with the present invention, habitat is provided for caged animals comprising a product preferably manufactured from milo seeds that have been decorticated resulting in berry and berry particulates that may be exposed directly to extrusion. The decorticated milo is then extruded to form the habitat in a desired shape, size, and density.

The milo grain preferably undergoes selection and processing prior to extrusion. First, a desired stock of milo grain is chosen, and the selected grain may then be cleaned and sized. In the cleaning operation, destoning may take place to remove any hard material of like size and shape, such as small stones or pebbles. The milo grain is then decorticated in one of several known methods of grain decortication. The decortication removes the husks or hulls of the milo seeds. Preferably, the remaining berry and berry particulates are then passed through a scourer to remove the fatty endogerm portion of the berries. Defatting of the berries enhances the ability of the milo grain to be extruded because under some circumstances, fat can act as a lubricant in extrusion thereby degrading the ability of an extruder to produce a consistent product. Also, defatting of the berries reduces the food value of the milo grain thereby minimizing any potential interference with an animal's prescribed diet.

The processed berries may then be extruded in an extrusion device under preferred heat and pressure ranges. One advantage of extrusion is that it also serves to kill bacteria and other microbes thereby reducing the chance that an animal will become infected from the habitat.

Depending upon the moisture content of the milo to be extruded, as well as the pressure and temperature under which the milo is extruded, products can be created that have a wide range of shape, size, and density.

For use as habitat within the present invention, the extruded milo may take many forms. For example, the milo may be extruded in the form of a tubular or cylindrical shape, and sized so that an animal may use the product as a nest, or otherwise may crawl through and around the product. In another form, the extruded milo may be much smaller, pellet sized products that an animal can use to create bedding or a nest, or to otherwise play with according to the animal's natural instincts. Yet another product that may be formed from the extrusion is a very light, puffy product that an animal could also utilize for bedding, or to otherwise use according to the animal's instincts.

Also in accordance with the present invention, a method is provided for enriching the environment of a caged animal by providing an extruded product of a desired shape, size, and density, and then introducing those selected products to the environment in which the caged animal resides. Some animals may prefer a lighter, puffier product, while others may prefer the smaller, denser pelletized products. Therefore, an animal's behavior could be observed to provide the desired product(s) to best enrich/enhance the animal's environment. Improving the environment of an animal by providing the habitat may reduce the severity of the Hotel Syndrome or other negative behavior patterns.

Other features and advantages of the present invention will become apparent from a review of the following detailed description, taken in conjunction with the drawings.

### BRIEF DESCRIPTION OF THE DRAWINGS

FIG. 1 is a perspective view of an animal cage containing one or more animals therein, along with the animal habitat of the present invention illustrated in various shapes and sizes;

FIG. 2 is a perspective view of one representative example of a product that may be produced for use as habitat in the form of a tubular or cylindrical shaped product;

FIG. 3 is a plan view of the product of FIG. 2;

FIG. 4 is a perspective view of another product that is a modification of the product shown in FIG. 1;

FIG. 5 is another example of a product that may be produced for use as habitat that is smaller, denser, and pellet-like in shape; and

FIG. 6 is another example of a product that may be produced for use as habitat in the form of a light, puffy extruded product.

### DETAILED DESCRIPTION

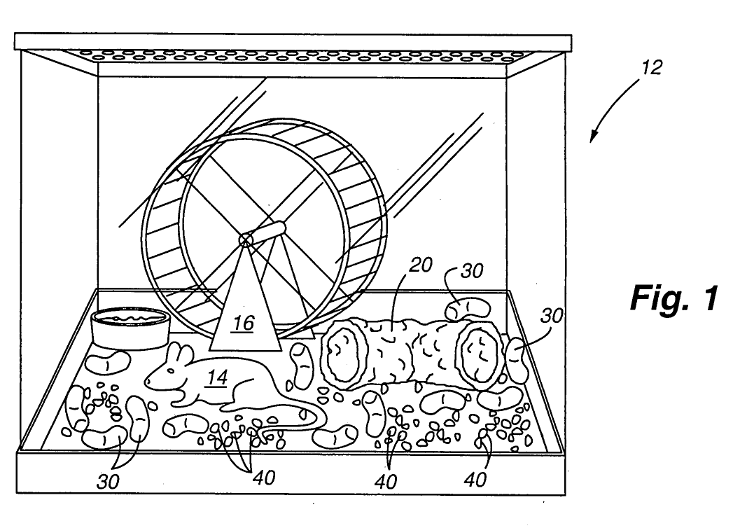

Referring to FIG. 1, an animal cage 12 is shown as being representative of any type of device used to hold captive one or more animals that may be used for testing, such as in the medical field. One or more animals 14 reside in the cage and are strictly monitored for their response to testing that may be conducted on the animals. The cage may contain an existing play toy or exercise device 16 that is intended to provide the animal with some form of enrichment, the specific device 16 shown in the figure being representative of a stationary treadmill device commonly used for rodents. As necessary, the cage may further include litter (not shown) to absorb animal waste thereby providing a more healthful environment for the animal.

Also shown in FIG. 1 are various forms of the habitat of the present invention. In one form, the habitat can be a product 20 having a tubular or cylindrical shape that allows the animal to nest, or otherwise to crawl through and around it. Another example of a habitat of the present invention includes a product 30 that may be characterized as having a light, puffy consistency, and may be sized to allow the animal to create a nest within the product 30, or to otherwise transport the product 30 and create a nest/bed with product 20. Yet another example of the habitat of the present invention that may be provided is a product 40 having a denser, smaller configuration, such as a pellet-like product. An animal may use the product 40 for various uses to include nesting, play, etc. Of course, an animal may develop other individual purposes or uses for the products 20, 30, and 40, the above stated uses simply being potential uses by the animal.

Sorghum vulgare is one of the oldest domesticated plants known to man. It has been hybridized since early Egyptian years and is very diversified in its hybrid state. Varieties commonly referred to as milo have few uses other than for animal feed. Sorghum vulgare is widely used in the U.S. as a less expensive feed grain in comparison to corn or wheat. In other parts of the world, particularly Africa and Asia, Sorghum is used for flour and human food. In the United States, milo as a particular group of hybrids, is a very different type of cereal grain as compared to Sorghum which is grown in other parts of the world.

Each of the products 20, 30, and 40 are created from extruded milo. In order to best control extrusion, the raw milo grain may be treated. One consideration in production of the products is to select a pure stock of grain because an extrusion process performed on a substantially pure grain stock provides a more consistent product from one batch processing to the next. The chosen milo grain may be cleaned and sized by standard cleaning and sizing equipment, such as equipment that utilizes air/water streams to clean the grain. The grain may then be passed through various sieves to obtain the desired grain size. Destoning of the grain may also be conducted to remove stones or other similar sized objects that may still remain in the grain after cleaning and sizing. The grain is then decorticated. Any well known methods of grain decortication can be used. A next step would be scouring of the grain to remove fatty oils or lipids. Removing these substances not only improves the consistency and repeatability of the extrusion, but also minimizes the food value of the extruded milo grain, thereby minimizing impacts on an animal's prescribed diet.

After decortication, the grain may be extruded. One preferable type of extruder may include a bake-type extruder which exposes the grain to heat in the range of about 325° F. to about 400° F., and pressure in the range of about 1500 psi to about 2000 psi. The particular shape of the die used in the extruding machine may be adapted to produce a product of a desired shape and size. Also, the cutting mechanism used in the extruding machine can be adapted for cutting the extruded product to a desired length. As well understood, one effect of extrusion can be expansion of the product as it leaves the die of the extruder. By controlling the amount of expansion that the grain experiences during extrusion, the density of the product may also be controlled. One important factor in controlling expansion is extruding the grain at a desired moisture content.

To produce the product 20, it has been found in testing that providing milo grain having a moisture content of about 16-18% immediately prior to extrusion allows the product 20 to be very hard and stiff, making the product 20 ideal for the animal to use as a housing or shell for a nest. The product 20 may also serve as a toy allowing the animal to crawl through and around the product. Alternatively, a product 30 that is light and puffy, can be prepared by providing milo grain having a moisture content of about 16% immediately prior to extrusion. Alternatively, a pellet-like product 40 can be prepared by providing milo grain having a moisture content of less than about 16% immediately prior to extrusion and preferably less than about 10% immediately prior to extrusion.

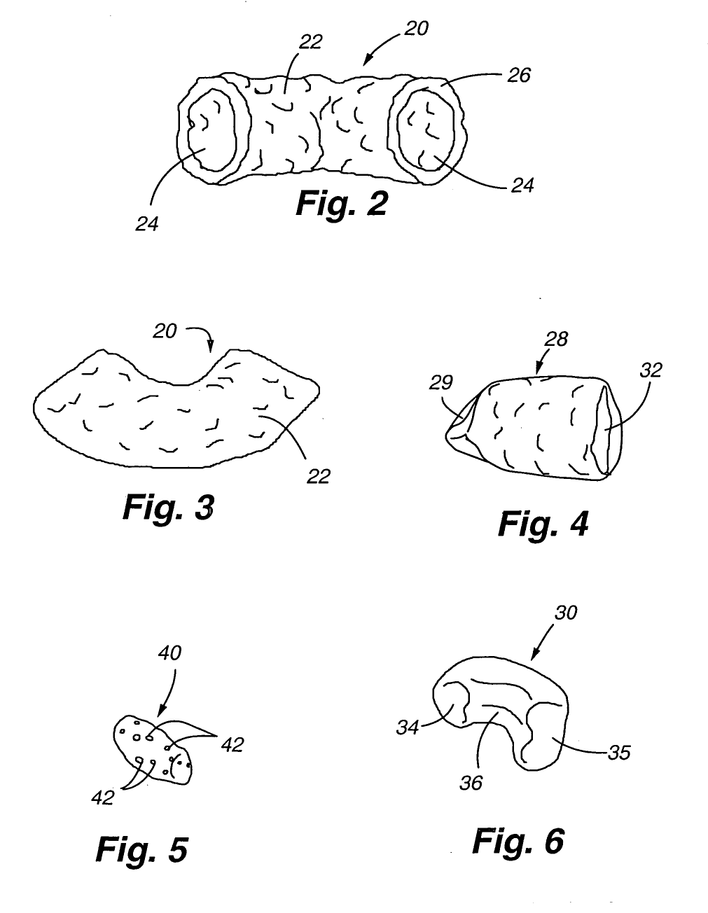

FIG. 2 illustrates the product 20 characterized by an outer shell 22, and a hollow interior, defining a cavity or open space 24. The product 20 may have a thickness 26 determined in the extrusion process. Preferably, the thickness 26 is in the range of about one-eighth inch to about four inches. More preferably, the thickness 26 is in the range of between about one-quarter inch and about 1 inch. As desired, the product 20 may be tubular, and may further be curved or arcuate shaped, as shown in the plan view of FIG. 3.

FIG. 4 illustrates a modification to the product 20 wherein a product 28 is provided having one end 29 that is closed. Accordingly, the product 28 will include an opening defining a cavity 32, but the cavity does not extend completely through the product because of the closed end 29. This particular product 28 may be easily manufactured by extruding the product 28, and using a cutting tool which crimps the end 29 as opposed to making a clean cut as with the product 20.

FIG. 6 illustrates the product 30 which may be puffy and light, similar to packing peanuts. The product 30 may be of any desired shape, and is shown in FIG. 6 as having ends 34 and 35, and a curve shaped body 36.

FIG. 5 illustrates the product 40 which may resemble a pellet. Depending upon the effects of extrusion, product 40 may include the plurality of open cells 42. Alternatively, the result of extrusion may provide the products with a very smooth and unbroken exterior surfaces.

One particular advantage with the use of milo is that extruded milo grain has a very long shelf life, and therefore may be stored for long periods of time prior to use without degradation or contamination. Thus, while the extruded milo grain is ultimately biodegradable, the extruded milo grain will not break down or decompose for a long period of time, well after the time in which the extruded grain is used as habitat.

Another distinct advantage of using an extruded milo grain for habitat in the present invention is that production of a habitat is achieved with a relatively simple grain processing method. Another advantage of extruded milo grain is that it is generally hydrophobic, therefore very stable in all climates and storing conditions.

Another advantage to the present invention is that the habitat helps to protect the animals from the environment of a laboratory that is not necessarily comfortable or natural for the animals. More specifically, particularly for rodents, their natural environment is not one which is exposed to bright light or well ventilated areas. In a laboratory for various reasons, it is advantageous to maintain the laboratory at a high lighting condition, as well as being well ventilated. These environmental factors are unnatural for a rodent. Accordingly, the habitat of the present invention helps to shield a rodent from the high light and ventilation, allowing the animal to burrow and create shelter from these environmental conditions. Accordingly, the animal will be able to better withstand the stresses created by the environmental factors.

In the event that the extruded milo grain is consumed by an animal, the extruded milo grain is palatable and easily digestible by all animals. Because of the relatively low food value of the extruded and defatted milo grain as compared to other extruded grains, there is minimal dietary disruption if the animal ingests the habitat. Through testing of a sample of the extruded grain, it has been found that it contains approximately 82% carbohydrates, 1% fat, 8% protein, and no detectable amounts of sugars or cholesterol. It was also found through testing that the total digestible nutrients for the extruded milo was approximately 74%. Accordingly, the habitat provides minimal nutrition if consumed, and certainly less nutrition than other extruded grains.

It is also contemplated within the present invention that the milo grain can be supplemented with one or more additives to achieve a specific purpose. For example, rodents have incisor teeth that will become unnaturally long obstacles, possibly interfering with the feeding of the animal. Normal gnawing and chewing behavior exhibited by rodents naturally keeps the incisors at a reasonable length. However, in a sterile or minimal habitat devoid of articles upon which the rodent can chew or gnaw, the rodent's incisors may grow to interfere with normal eating patterns and thereby further disrupt experimentation. In the present invention, an abrasive substance, such as silica and the like, can be added to the milo grain prior to extrusion. Assuming an animal was prone to chew or gnaw on the habitat, the silica greatly assists in maintaining the incisor teeth.

In accordance with the method of the present invention, an animal's environment is enriched with introduction of the habitat. The method includes producing the products 20, 28, 30, and 40, and introducing the products into the environment in which the animal is housed. As the animal is observed, the particular products that the animal may show most interest in can be supplemented. Therefore, various combinations of the products can be provided to best suit the behavior of a particular animal. Accordingly, the method contemplates observation of the animal over time to tailor a desirable combination of the extruded products to best enrich the environment.

The habitat and method of the present invention have been provided with respect to preferred embodiments; however, other modifications and changes may be made within the spirit and scope of the invention, as claimed.

1-21. (canceled)

22. Habitat for caged animals comprising an extruded milo grain.

23. Habitat, as claimed in claim 22, wherein:
said extruded milo grain is decorticated and defatted.

24. Habitat, as claimed in claim 22, wherein:
said habitat has at least two distinct shapes.

25. Habitat, as claimed in claim 22, wherein:
said habitat has at least two distinct sizes.

26. Habitat, as claimed in claim 22, wherein:
said habitat has at least two distinct densities.

27. Habitat, as claimed in claim 22, wherein:
said habitat includes a hollow interior.

28. Habitat, as claimed in claim 22, wherein:
said habitat has a tubular shape.

29. Habitat, as claimed in claim 22, wherein:
said habitat has multiple shapes, at least some of which are tubular.

30. Habitat, as claimed in claim 22, wherein:
moisture content of the milo grain is altered prior to extrusion thereby varying a density of the habitat produced by the extrusion.

31. Habitat, as claimed in claim 22, further including:
an additive mixed with the extruded milo grain.

32. Habitat, as claimed in claim 22, wherein:
said additive includes silica.

33. Habitat, as claimed in claim 22, wherein:
said habitat is pellet-shaped.

34. Habitat, as claimed in claim 22, wherein:
said habitat has less than about 1% cholesterol.

35. Habitat, as claimed in claim 22, wherein:
said habitat has less than about 2% fat.

36. Habitat, as claimed in claim 22, wherein:
said habitat has less than about 1% sugars.

37. Habitat, as claimed in claim 22, wherein:
said habitat has less than about 85% carbohydrates.

38. Habitat, as claimed in claim 22, wherein:
said habitat has a total digestible nutrient count not exceeding approximately 80%.
